(19) United States
(12) Patent Application Publication
(10) Pub. No.: US 2003/0150062 A1
(43) Pub. Date: Aug. 14, 2003

(54) Wire stripper with integral screwdriver

(76) Inventor: Wayne Muirhead, Ithaca, NY (US)

Correspondence Address: BROWN & MICHAELS, PC, 400 M & T BANK BUILDING, 118 NORTH TIOGA ST, ITHACA, NY, 14850, US

(21) Appl. No.: 10/073,469

(22) Filed: Feb. 11, 2002

(51) Int. Cl. B25B 25/00

(52) U.S. Cl. 7/108

(57) ABSTRACT

A wire stripper with integral screwdriver has a pair of levers pivotally connected at a fulcrum point to each other. Each lever has a handle and a jaw on opposite sides of the fulcrum point. The jaws have a plurality of notches of different curvatures, which come together in a closed state for stripping insulation from electrical wires of different gauges, and also have a scissors area for cutting electrical wires. One of the jaws is extended and includes an integral screwdriver tip. In a preferred embodiment, when the tool is in a closed position, the handles are closed together to form a single integral screwdriver handle. The tool can be used for stripping wire and screwing down electrical connections.

### BACKGROUND OF THE INVENTION

1. FIELD OF THE INVENTION

The invention pertains to the field of hand tools. More particularly, the invention pertains to tools for stripping insulation from electrical wires of different gauges, and conductors.

2. DESCRIPTION OF RELATED ART

Various scissors-like wire strippers have been developed. Such devices have elongated opposing jaws with a series of semi-circular notches spaced along the length of both jaws. Each notch is tapered to provide a sharp semi-circular edge for cutting into the insulation around a conductor. The radii of each pair of opposing notches corresponds to different gauges of the solid conductors used in electrical wiring. In order to strip insulation from an individually insulated wire, the wire is placed into the openings of the notches in the opposing jaws which corresponds to the gauge of the conductor within the wire. Then the handles of the stripper are squeezed together forcing the jaws into the insulation until the jaws are fully closed. In this position, the jaws have pierced the insulation, but have not cut into the internal conductor. The conductor of the wire then is pulled through the closed jaws of the stripper removing the insulation from the conductor.

It is desirable to provide a tool which integrates a scissors-like wire stripper and a screwdriver so that a single tool can be used to strip the electrical wire and screw it to the electrical connection.

In order for an electrician to connect an electrical device to the wire, the metal conductors within the insulated wires have to be exposed. The electrician must first strip away the insulation to expose the wire, and then must use a screwdriver to screw the wire to the connection. This requires the electrician to switch between using a wire stripper and a screwdriver. The present invention provides a single tool which enables the electrician to both strip the wire and screw it to the connection. The present invention thereby ends the burden of having to carry two tools to complete an electrical connection. The present invention integrates a screwdriver tip and a screwdriver handle into a scissors-like wire stripper. The present invention provides an extended integral screwdriver tip, and also provides a single integral screwdriver handle, which provides the proper torque capability required to screw down the connection sufficiently. The present invention implicitly provides the leverage capability common to scissors-like wire stripping tools. Such leverage is required to effectively strip and cut the gauges of wire commonly encountered by an electrician. The present invention saves time for the electrician because it eliminates the burden of switching back and forth between a wire stripper and a separate screwdriver when completing electrical connections.

### SUMMARY OF THE INVENTION

The present invention provides a tool, which can be used to rapidly and efficiently remove insulation from electrical conductors.

The invention further provides a tool, which can be used to efficiently screw the wire to the electrical connection.

The invention provides a single tool, which can be used for removing the insulation from a wire and screwing it to an electrical connection.

The preferred embodiment of the invention has first and second levers pivotally connected in a scissors-like manner. The first lever has a first handle, a first jaw and a first intermediate portion between the first handle and the first jaw. The first jaw possesses a first surface with a plurality of notches cut at different radii for stripping insulation from electrical wires of different gauges, and a scissors area for cutting wires. The second lever is of similar design and includes a second handle, a second jaw and a second intermediate portion therebetween. The second jaw also has a second surface with a plurality of notches cut at different radii corresponding to the opposing notches in the first jaw, and a scissors area. A pivot couples the first and second intermediate portions thereby enabling the first and second surfaces alternately to be brought into and away from abutment.

A preferred embodiment of the tool has one of the jaws extending beyond the other and includes an integral screwdriver tip at the end of the extended jaw.

An alternate embodiment of the tool has an extended jaw, which provides reach for applying the integral screwdriver tip.

The preferred embodiment of the tool has handle grips which are closed together when the tool is in the closed position to form a single integral screwdriver handle which is circular or oval around its axis and is rounded at its butted end.

### BRIEF DESCRIPTION OF THE DRAWING

FIG. 1 shows a side view of a tool according to the preferred embodiment of the present invention, which can be used for removing insulation from a wire and screwing the wire to the electrical connection.

FIG. 2 shows a side view of the preferred embodiment of the tool in its closed position.

FIG. 3 shows a rear view of the preferred embodiment of the tool it its closed position.

### DETAILED DESCRIPTION OF THE INVENTION

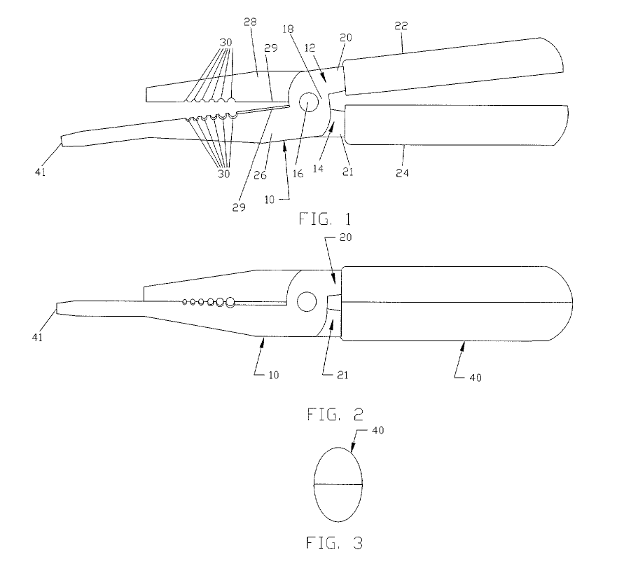

With reference to FIG. 1, tool 10 comprises a pair of levers 12 and 14, pivotally connected to one another, preferably by a bolt and nut, or similar fastening means, collectively designated 16, extending through holes in each lever. The levers 12 and 14 preferably have an intermediate portion 18 from which handles 20 and 21 extend in one direction. The handles 20 and 21 preferably are covered by grips 22 and 24 respectively. Each lever 12 and 14 has a jaw 26 and 28 extending in the opposite direction from the handles. The jaws 26 and 28 have a pair of facing surfaces within which a set of notches 30, preferably being semi-circular, are cut at different radii which correspond to different gauges of wires to be stripped. The jaw surface preferably is tapered around each notch 30 to form sharp edges for biting into the wire insulation. The edge of each jaw 26 and 28 between the set of notches 30 and the intermediate lever portion 18 preferably is beveled to a sharp edge, thereby forming a scissors section 29 of the tool 10.

With reference to FIGS. 1 and 2, one of the jaws 26 is preferably extended further than the other and includes an integral screwdriver tip 41 at the end of it. The handle grips 22 and 24, which are preferably made of plastic or rubber, are closed together when the tool is in the closed position to form a single integral screwdriver handle 40 which is preferably circular or oval around its axis and rounded at its butted end as shown in FIG. 3. The present invention provides cooperating elements 41 and 40, which are used to screw down the connection.

The preferred embodiment of the tool 10 can be used as a screwdriver to screw down any connection and/or for any application where scissors-like wire strippers can be used.

First, the insulation from each of the individual wires is removed utilizing the notches 30 on the opposing surfaces of the jaws 26 and 28, as previously described. The preferred embodiment of the invention provides an extended jaw 26, which includes an integral screwdriver tip 41. The present invention also provides a single integral screwdriver handle 40. Together these elements can then be used to screw down the connection.

While the preferred embodiment of the present invention is described and shown herein as integrally including a screwdriver tip, it will be apparent to one of ordinary skill in the art that any type of screwdriver tip or driver tip can be substituted therefor, including a wide variety of screwdriver tip types and driver tip types, which are well-known in the art.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tool comprising:
a first lever including a first handle portion, a first jaw and a first intermediate portion between the first handle portion and the first jaw, the first jaw having a first surface with a plurality of notches, suitable for stripping insulation from electrical wires of different gauges, and a scissors area for cutting electrical wires; and
a second lever including a second handle portion, a second jaw and a second intermediate portion between the second handle portion and the second jaw, the second jaw having a second surface with a plurality of notches, suitable for stripping insulation from electrical wires of different gauges, and a scissors area for cutting electrical wires; and
wherein the first and second intermediate portions are pivotally connected together enabling the first and second surfaces to be moved alternately toward and away from each other and into abutment; and
wherein at least one of said first and second levers includes an integral screwdriver tip.

2. The tool of claim 1, wherein the integral screwdriver tip is formed by a jaw surface which lies in the same plane as its lever, and points in the opposite direction of the handles, and adjoins the jaw's inner surface.

3. The tool of claim 1, wherein the integral screwdriver tip is formed by a jaw surface which lies in the same plane as its lever, and points in the opposite direction of the handles, and adjoins the jaw's inner surface, and is extended.

4. The tool of claim 1, wherein a portion or an extended portion of the integral screwdriver tip is formed by a surface of both levers wherein the entire integral screwdriver tip is applied when the tool is in the closed position.

5. The tool of claim 1, wherein the integral screwdriver tip can be any one of the following types of tip or any other type of tip which could be used as a screwdriver tip or a driver tip.
a. phillips;
b. slotted;
c. hex;
d. square;
e. phillips/slotted combination;
f. phillips/square combination;
g. hex

6. The tool of claim 1, wherein the handles are covered by grips which are closed together when the tool is in the closed position to form a single integral screwdriver handle, which is circular or oval around its axis and is rounded at its butted end, or which is any suitable or performance enhancing shape, size, texture, or material.

7. The tool of claim 1, wherein the screwdriver tip is rigidly attached with suitable means.
